(19) United States
(12) Patent Application Publication
(10) Pub. No.: US 2017/0193063 A1
(43) Pub. Date: Jul. 6, 2017

(54) MOBILE DEVICE AND METHOD OF ACQUIRING AND SEARCHING FOR INFORMATION THEREOF

(71) Applicant: Samsung Electronics Co., Ltd., Suwon-si (KR)

(72) Inventors: Ayushi GUPTA, Noida (IN); Anupam DUTTA, Delhi (IN); Basava Raju KANAPARTHI, Vijayawada (IN); Munwar KHAN, Delhi (IN); Nitesh KHILWANI, Ghaziabad (IN); Sanket Suresh MAGARKAR, Noida (IN); MAHELAQUA, Delhi (IN)

(21) Appl. No.: 15/213,855

(22) Filed: Jul. 19, 2016

(30) Foreign Application Priority Data
Jan. 6, 2016 (IN) 201611000525
Apr. 1, 2016 (KR) 10-2016-0040369

(51) Int. Cl. G06F 17/30; H04M 1/725; G06F 3/0481; H04W 52/02; G06F 3/0484; G06F 3/0487; H04W 8/18

(52) U.S. Cl. CPC G06F 17/30554; G06F 3/0487; H04M 1/72547; H04W 8/183; H04M 1/72561; H04W 52/0254; G06F 3/04847; G06F 3/0481; G06F 17/30144

(57) ABSTRACT

A method of searching for information in a mobile device is provided. The method includes identifying at least one log for operational events based on at least one input parameter, identifying at least one element existing within the at least one log based on the at least one input parameter, fetching contents related to the at least one element from the at least one log, and displaying a portion of the contents.

### CROSS-REFERENCE TO RELATED APPLICATION(S)

This application claims the benefit under 35 U.S.C. §119(a) of an Indian patent application filed on Jan. 6, 2016 in the Indian Intellectual Property Office and assigned Serial number 201611000525, and of a Korean patent application filed on Apr. 1, 2016 in the Korean Intellectual Property Office and assigned Serial number 10-2016-0040369, the entire disclosure of each of which is hereby incorporated by reference.

### TECHNICAL FIELD

The present disclosure relates to a mobile device and an information managing method thereof. More particularly, the present disclosure relates to a mobile device and a method of searching for and acquiring information thereof.

### BACKGROUND

The usage of mobile devices such as smartphones, tablets, and palm tops has surged in the last decade, and various mobile applications (or mobile apps) ranging from health check to movie ticket reservation are used to assist almost every day-to-day task of a user. Accordingly, various pieces of data are generated over various mobile applications. Typically, when different mobile apps are used successively in a particular situation, for example, when the user downloads a movie through a video app, exchanges messages about a movie download with one of his/her friends through a message app, and updates his/her social networking status immediately after having completed the movie download through a social networking mobile app, pieces of data are stored in different heads. In other words, the mobile device breaks activity contents related to a particular situation based on application types and stores them in different mobile apps.

According to a data access-centralized mechanism, there are some mobile apps (for example, gallery) that collect different types of data and store the data in the existing mobile device. These apps store multimedia-media based contents based on time, events, locations, and third-party execution mobile-apps. For this reason, the app may include a plurality of categories for storing multi-media contents such as events, timeline, third-party execution mobile apps, Bluetooth, and downloads. However, not only the categories are limited in number, but also a major portion of the contents of the mobile device cannot be found through such mobile app. Even in respect to the access to the contents through such mobile apps, as the categories (for example, photos, videos, and download) of the contents are substantially broad and include a huge amount of data, the user is required to perform a repeated scrolling for all the categories of data.

As a result, considering a scenario in which the user forgot the name or number of a friend with whom he/she exchanged messages while downloading the movie, the user has limited options to ascertain the details. In a first method, the user accesses a message log and manually performs a search. The search may be successful when the user remembers the date and/or time when the download was performed. In a second method, the user remembers the movie title, accesses a movie download log, and identifies details of the movie download (for example, date and time). Based on such details, the user has to again go back to the message log to find the message based on the identified movie details. As described above, the methods prove substantially cumbersome. In other words, since the contents are separately stored in different applications, the user must separately access logs of the applications to search for information. However, even though the user performed a sufficient search operation and consumed a considerable amount of time, an accurate result may not be guaranteed. The probability of finding the accurate results further worsens as a considerable time has elapsed from the occurrence of the particular situation and successive operations in the mobile device because the user may only remember vague details about his/her activity or executed communications through the mobile device.

There are certain mechanisms in mobile devices in which automatic tags such as time, data type and location are associated with the contents to provide an easy search to the user. However, such mechanisms rely upon a continuous indexing of all contents in the mobile device, thereby always rendering over-occupancy of the processor and draining energy resources, such as a battery. Moreover, the search for information related to particular contents requires a specific and complex character string for pulling out information and, accordingly, requires a specific-skill exhibition from the user, so the mechanisms are limited in many ranges.

Another type of content location mechanism in the mobile device includes reporting all activities (captured images, browsed web-sites, and phone calls) activated in all mobile phones and all outdoor activities (distance of running, walking steps, value of burnt calories) for a particular day in a week. However, since the mechanism should collect quite a large amount of information to be shown as reported results, an ample effort of user-conducted navigation is still required to arrive at the precise information. Accordingly, the mechanism suffers from the problem of excessive utilization of resources by the mobile device.

There exists a need for the mechanism that not only searches for information within the mobile device in a time-efficient and user-friendly manner, but also proves substantially less burdensome in respect to resource utilization in the mobile device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a mobile device and an information managing method thereof.

In accordance with an aspect of the present disclosure, a method of searching for information in a mobile device is provided. The method includes identifying at least one log for operational events based on at least one input parameter, identifying at least one element existing within the at least one log based on the at least one input parameter, fetching contents related to the at least one element from the at least one log, and displaying a portion of the contents.

In accordance with another aspect of the present disclosure, a mobile device is provided. The mobile device includes a display device, an input device configured to receive at least one input parameter, and a processor functionally connected to the display device and the input device. The processor is configured to identify at least one log for operational events based on the at least one input parameter, identify at least one element existing within the at least one log based on the at least one input parameter, fetch contents related to the at least one element from the at least one log, and to display a portion of the contents.

In accordance with another aspect of the present disclosure, a method of acquiring information in a mobile device is provided. The method includes detecting a user specific condition, monitoring at least one operational event based on the user specific condition, accessing at least one element related to the at least one operational event, generating a log of the at least one operational event, and registering the at least one element in a predetermined location within the log.

In accordance with another aspect of the present disclosure, a mobile device is provided. The mobile device includes a memory, an input device configured to receive a user specific condition, and a processor functionally connected to the memory and the input device. The processor is configured to monitor at least one operational event based on the user specific condition, access at least one element related to the at least one operational event, generate a log of the at least one operational event, and register the at least one element in a predetermined location within the log.

According to the present disclosure, the mobile device may allow the user to easily search for and track desired contents. That is, the mobile device may permit the user to easily access desired contents without a user's search query.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart according to an embodiment of the present disclosure;

FIG. 2 illustrates a mobile device according to an embodiment of the present disclosure;

FIG. 3 is a flowchart according to an embodiment of the present disclosure;

FIG. 4 illustrates a mobile device according to an embodiment of the present disclosure;

FIG. 5 is a flowchart according to an embodiment of the present disclosure;

FIG. 6 illustrates an operation according to an embodiment of the present disclosure;

FIGS. 7A, 7B, and 7C illustrate a particular type of operation related to FIG. 6 through a user interface application according to an embodiment of the present disclosure;

FIG. 8 illustrates an image representation of the operation of FIGS. 7A to 7C according to an embodiment of the present disclosure;

FIGS. 9A, 9B, and 9C illustrate another type of operation related to FIG. 6 through a user interface application according to an embodiment of the present disclosure;

FIG. 10 illustrates the operation of FIG. 1 according to relevant entities according to an embodiment of the present disclosure;

FIG. 11 illustrates operations according to an embodiment of the present disclosure;

FIG. 12 illustrates an operation associated with FIG. 11 through a user interface according to an embodiment of the present disclosure;

FIG. 13 illustrates another type of operation associated with FIG. 11 through a user interface according to an embodiment of the present disclosure;

FIG. 14 illustrates the operations of FIGS. 3 and 5 according to relevant entities according to an embodiment of the present disclosure;

FIG. 15 illustrates a detailed structure of the mobile device illustrated in FIG. 2 according to an embodiment of the present disclosure;

FIG. 16 illustrates a detailed structure of the mobile device illustrated in FIG. 4 according to an embodiment of the present disclosure; and

FIG. 17 illustrates an implementation of the mobile device illustrated in FIGS. 2 and 4 in a computing environment according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the present disclosure, the expression “have”, “may have”, “include” or “may include” refers to existence of a corresponding feature (e.g., numerical value, function, operation, or components such as elements), and does not exclude existence of additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first electronic device and a second electronic device may indicate different user devices regardless of order or importance thereof. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them. In contrast, it may be understood that when an element (e.g., first element) is referred to as being “directly connected,” or “directly coupled” to another element (second element), there is no element (e.g., third element) interposed between them.

The expression “configured to” used in the present disclosure may be exchanged with, for example, “suitable for,” “having the capacity to,” “designed to,” “adapted to,” “made to,” or “capable of” according to the situation. The term “configured to” may not necessarily imply “specifically designed to” in hardware. Alternatively, in some situations, the expression “device configured to” may mean that the device, together with other devices or components, “is able to.” For example, the phrase “processor adapted (or configured) to perform A, B, and C,” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a Moving Picture Experts Group phase 1 or phase 2 (MPEG-1 or MPEG-2) audio layer-3 (MP3) player, a mobile medical device, a camera, and a wearable device. According to various embodiments of the present disclosure, the wearable device may include at least one of an accessory type (e.g., a watch, a ring, a bracelet, an anklet, a necklace, glasses, a contact lens, or a head-mounted device (HMD)), a fabric or clothing integrated type (e.g., electronic clothing), a body-mounted type (e.g., a skin pad, or tattoo), and a bio-implantable type (e.g., an implantable circuit).

According to some embodiments of the present disclosure, the electronic device may be a home appliance. The home appliance may, for example, include at least one of a television (TV), a digital versatile disc (DVD) player, an audio player, a refrigerator, an air conditioner, a cleaner, an oven, a microwave oven, a washing machine, an air purifier, a set-top box, a home automation control panel, a TV box (e.g., HomeSync™ of Samsung, Apple TV™, or Google TV™), a game console (e.g., Xbox™, PlayStation™), an electronic dictionary, an electronic key, a camcorder, and an electronic frame.

According to an embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a movie camera, a computed tomography (CT) machine, and an ultrasonic machine), a navigation device, a global navigation satellites system (GNSS), an event data recorder (EDR), a flight data recorder (FDR), vehicle infotainment devices, electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet of things (IOT) device (e.g., a light bulb, various sensors, electric or gas meter, a sprinkler device, a fire alarm, a thermostat, a streetlamp, a toaster, sporting goods, a hot water tank, a heater, a boiler, etc.).

According to some embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

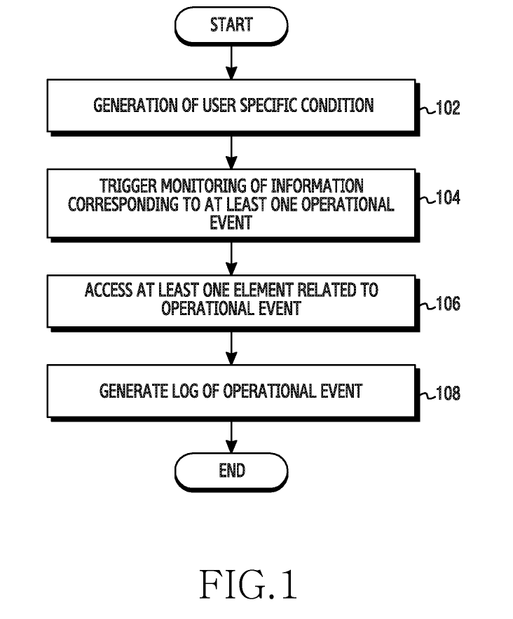

FIG. 1 is a flowchart according to an embodiment of the present disclosure.

Referring to FIG. 1, the present disclosure may provide a method of collecting information by a mobile device. According to this embodiment of the present disclosure, the mobile device may detect the generation of a user-specific condition in operation 102. The user-specific condition may be a user input provided to the mobile device to collect information corresponding to at least one operational event within the mobile device, and may include a user-defined keyword. For example, the operational event may be generated in a predetermined time frame or a particular location. Based on the detection, the mobile device may trigger the monitoring of information corresponding to the operational event in operation 104. Thereafter, the mobile device may access at least one element related to the operational event in operation 106, and may generate a log of the operational event in connection with the user input in operation 108. At this time, the mobile device may register the accessed element in the log. More specifically, the accessed element may be allocated to a designated location within the log.

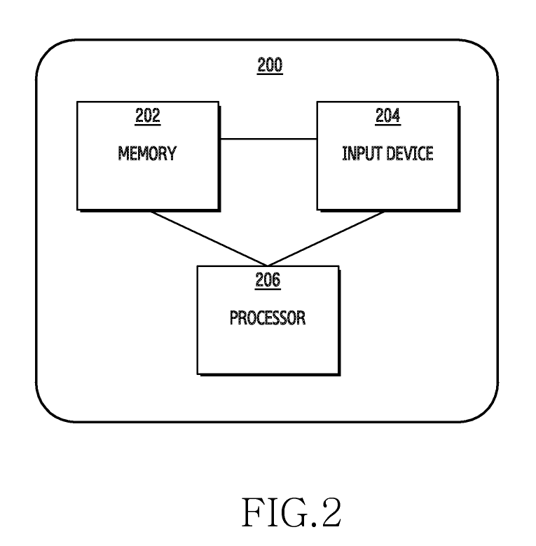

FIG. 2 illustrates a mobile device 200 according to an embodiment of the present disclosure.

Referring to FIG. 2, the mobile device 200 according to the present disclosure may be provided to collect information. The mobile device 200 may include a memory 202, an input device 204, and a processor 206.

The input device 204 may receive a user-specific condition. To this end, the input device 204 may sequentially render a graphic user interface (as described below). Further, the input device 204 may receive a user input through the graphic user interface.

The processor 206 may perform operations 104 to 108 based on the user-specific condition. That is, the processor 206 may monitor details and output results of at least one operational event based on the user input. In another scenario, the processor 206 may monitor already generated operational events and details/results related thereto. The two scenarios may be based on the type of received outputs. Accordingly, the processor 206 may generate a log based on the user input and may allocate a monitoring result to a designated location within the log.

Meanwhile, in the mobile device 200, the input device 204 and the processor 206 may perform their own functions, and the mobile device 200 may further include another element for enabling a functional mutual connection between the input device 204 and the processor 206.

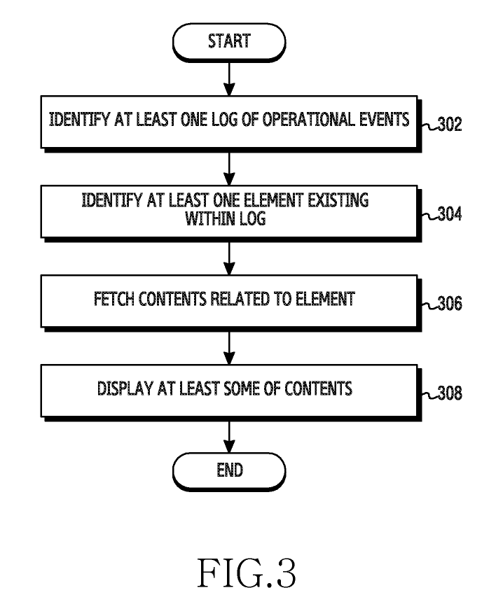

FIG. 3 is a flowchart according to an embodiment of the present disclosure.

Referring to FIG. 3, the present disclosure may provide a method of searching for information in the mobile device. According to this embodiment of the present disclosure, the mobile device may identify at least one log of operational events based on an input parameter received from the user in operation 302. The log may be identified from at least one log generated within the mobile device as a result of FIG. 1 or 2. Next, the mobile device may identify at least one element existing within the log at least based on the input parameter in operation 304. Meanwhile, other types of elements may be identified based on a reference that is different from that of the input parameter provided by the user, which will be described below. Continuously, the mobile device may fetch contents related to the identified element from a memory based on at least one identified element in operation 306. Lastly, the mobile device may display at least some (i.e., a portion) of the fetched contents as a final result in operation 308. At this time, the mobile device may display the final result according to a pattern based on a location of the identified element within the log.

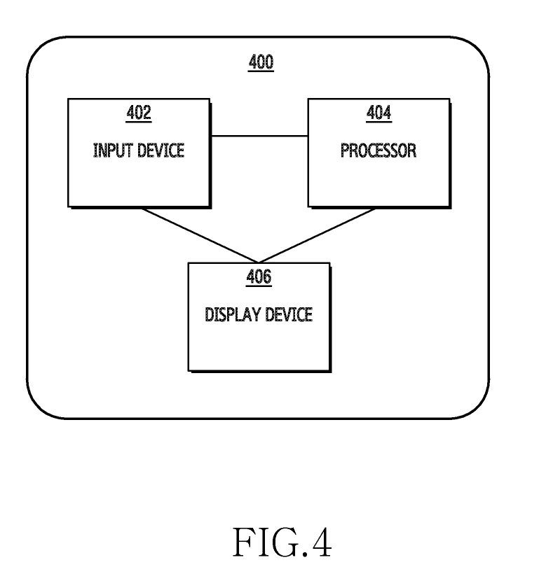

FIG. 4 illustrates a mobile device 400 according to an embodiment of the present disclosure.

Referring to FIG. 4, the mobile device 400, according to the present disclosure, may be provided to search for information. The mobile device 400 may include an input device 402, a processor 404, and a display device 406.

The input device 402 may receive at least one input parameter from the user. For example, the input parameter may be a search query for searching for information within at least one log, which was generated in advance.

The processor 404 may select at least one log based on an input parameter. The processor 404 may identify an element existing within the log based on the input parameter. Meanwhile, other types of elements may be identified based on a reference that is different from that of the input parameter provided by the user. Further, the processor 404 may fetch contents related to at least one identified element from a location of a main memory.

The display device 406 may display at least some (i.e., a portion) of the fetched contents as a final result. At this time, the final result may be displayed according to a pattern based on a location of the identified element within the log.

Meanwhile, in the mobile device 400, the input device 402, the processor 404, and the display device 406 may perform their own functions, and the mobile device 400 may further include another element for enabling a functional mutual connection between the input device 402, the processor 404, and the display device 406.

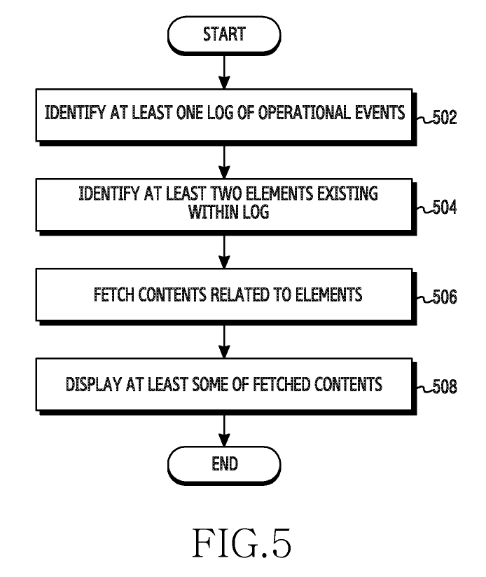

FIG. 5 is a flowchart according to an embodiment of the present disclosure.

Referring to FIG. 5, the present disclosure provides another method of searching for information in a mobile device. According to this embodiment of the present disclosure, the mobile device may identify at least one log of operational events based on an input parameter received from the user in operation 502. The log may be identified from at least one log generated within the mobile device as a result of FIG. 1 or 2. Next, the mobile device may identify at least two elements existing within the log in operation 504. At this time, the mobile device may identify one of the elements based on the input parameter. Next, the mobile device may fetch contents related to the identified elements in operation 506. Lastly, the mobile device may display at least some (i.e., a portion) of the fetched contents as a final result in operation 508. At this time, the mobile device may display the final result according to a pattern based on a location of the identified element within the log.

The operations described with reference to FIG. 5 may be executed by the input device 402, the processor 404, and the display device 406 illustrated in FIG. 4.

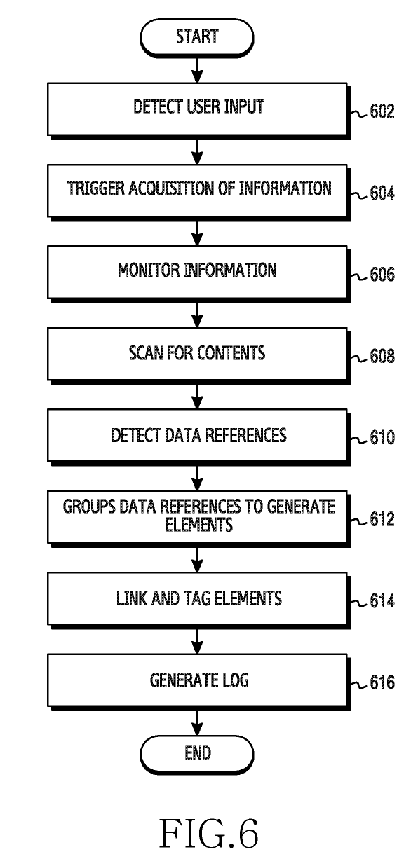

FIG. 6 illustrates an operation according to an embodiment of the present disclosure.

FIG. 6 may show a particular operation illustrated in FIG. 1 through successive operations but the present disclosure is not limited thereto. Further, the log may be interchangeable with “recaps” or “sachets.”

Referring to FIG. 6, the mobile device may detect the generation of a log, that is, a user input for triggering the generation of the log in operation 602. According to an example, the user input may be provided manually by the user. For example, the user input may be for generating a time-based log or a location-based log. The user input for generating the time-based log may acquire information related to an operational event generated within a predetermined time interval in the mobile device, and the user input for generating the location-based log may acquire information related to an operational event generated at a particular location.

The operational event may include at least one of an incoming call, an outgoing call, a received message, a transmitted message, Internet browsing through the mobile device, an operation performed by the user in the mobile device through a network, and an operation performed by the user in the mobile device, which is irrelevant to the network.

According to another example, the user input may be detected based on a user's state, which is sensed by the mobile device. The user's state may correspond to, for example, jogging or driving. Operation 602 may correspond to operation 102 of FIG. 1.

Next, the mobile device may trigger the acquisition of information in operation 604. Operation 604 may correspond to operation 104 of FIG. 1 and may be executed by the processor 206 of FIG. 2. To this end, the processor 206 may include, for example, a recap on-demand capture trigger module. When the user input is detected based on the user's state, the mobile device may immediately trigger the acquisition of the information. Meanwhile, when the user input is provided manually by the user, the mobile device may trigger the acquisition of the information when a condition existing within the user input is met.

Next, the mobile device may monitor information in operation 606. Operation 606 may correspond to operation 104 of FIG. 1 and may be executed by the processor 206 of FIG. 2. To this end, the processor 206 may include, for example, a data scan module. Through the data scan module, the mobile device may scan for actual contents stored in a designated memory or a database of the mobile device in operation 608. At this time, the contents to be scanned for may be already created contents in connection with the already generated operational event. In another scenario, the contents to be scanned for may include contents generated while the data scan module is executed. The contents to be scanned for may be determined according to a type of the user input detected in operation 602.

Meanwhile, for example, in a case where the mobile device is heavily occupied or under-charged even though the acquisition of the information is triggered, the mobile device may postpone the monitoring of the information. In such a scenario, when the mobile device switches to a charging standby state, an idle state, or a low occupied state, the mobile device may automatically trigger the monitoring.

Next, the mobile device may detect data references related to the scanned contents in operation 610. For example, when there are pre-generated data references corresponding to the scanned contents, the mobile device may detect the pre-generated references. Alternatively, when there are no pre-generated data references corresponding to the scanned contents, the mobile device may generate data references in connection with the scanned contents. The data references for the contents may indicate pointers for a memory location of the contents. Operation 610 may be executed by the processor 206 of FIG. 2. To this end, the processor 206 may include, for example, a raw data reference generator module.

Next, the mobile device may group the detected data references with other groups to generate elements in operation 612. Each group may indicate a particular category of data references indicating similar contents. Each of the grouped data references may indicate a single element. For example, data references indicating photos, videos, songs, and the like may be combined as various combinations to form a plurality of elements. Operation 612 may be executed by the processor 206 of FIG. 2. To this end, the processor 206 may include, for example, a recap reference data grouping module.

In operation 614, the mobile device may connect the elements to each other based on a particular user condition received in operation 602. Data references that are not grouped correspond to individual elements and may be connected to an element according to grouping. Further, the connected elements may be tagged by a description identifier, such as a tag. For example, elements indicating a birthday related message may be tagged by a birthday cake based identifier. Operation 614 may correspond to operation 106 of FIG. 1 and may be executed by the processor 206 of FIG. 2. To this end, the processor 206 may include, for example, a recap linking and auto tagging module.

Next, the mobile device may generate a log of information as a result of the connected elements in operation 616. A linkage between the elements may link the locations of the elements within the log. In other words, each element may be located at an inherent location in a chain formed by the linkage.

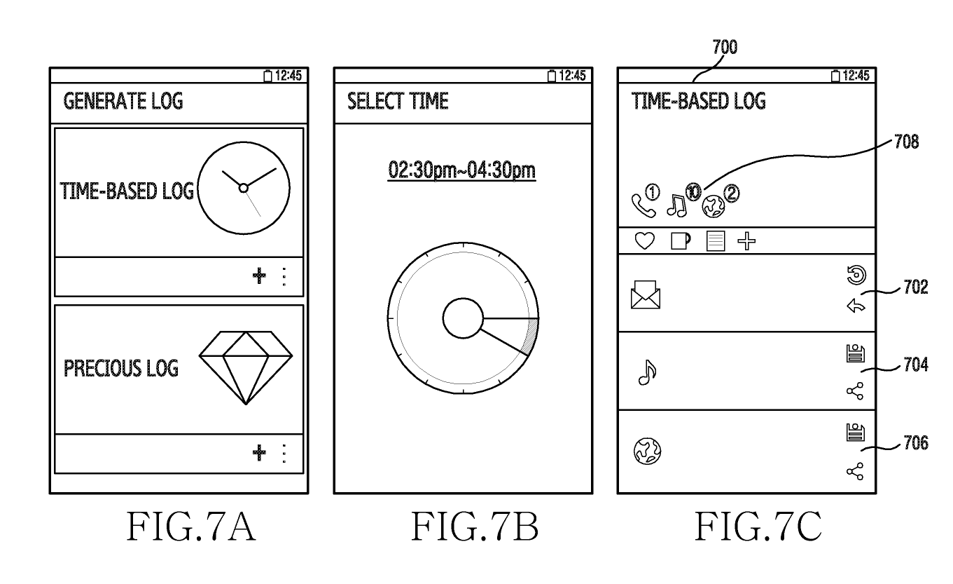

FIGS. 7A, 7B, and 7C illustrate a particular type of operation associated with FIG. 6 through a user interface application according to an embodiment of the present disclosure. More specifically, FIGS. 7A to 7C illustrate the generation of a time-based log through a user interface.

Referring to FIG. 7A, a time-based log (e.g., time-based log 700 of FIG. 7C) may be one of a plurality of options for generating the log. According to the selection of the option, the user may further select a time interval, for example, from 2:30 p.m. to 4:30 p.m. as illustrated in FIG. 7B. As a result, the mobile device may operate as described above and may generate the time-based log 700 as illustrated in FIG. 7C. The time-based log 700 may indicate a notification or data related to an operational event generated during the time interval. The operational event may include, for example, a message 702, a reproduced song 704, and details 706 of a found website. Further, the song 704 within the time-based log 700 may indicate a group of 10 songs, that is, a group of relevant operational events.

Further, in the time-based log 700, each element may be located according to a generation time. For example, according to the time-based log 700, the song 704 may be accessed after an Internet search within the mobile device and before a message exchange with another subscriber. Accordingly, without proceeding to details of the time, visual expressions of the linkage between elements in the time-based log 700 may indicate the generation order of the operational events of the mobile device.

Further, in the time-based log 700, symbols 708 related to a message, music, and Internet browsing may briefly indicate operational events. Each symbol 708 may indicate the number of notifications through a number. For example, the symbol 708 indicating music and having a number 10 may indicate that 10 songs are included.

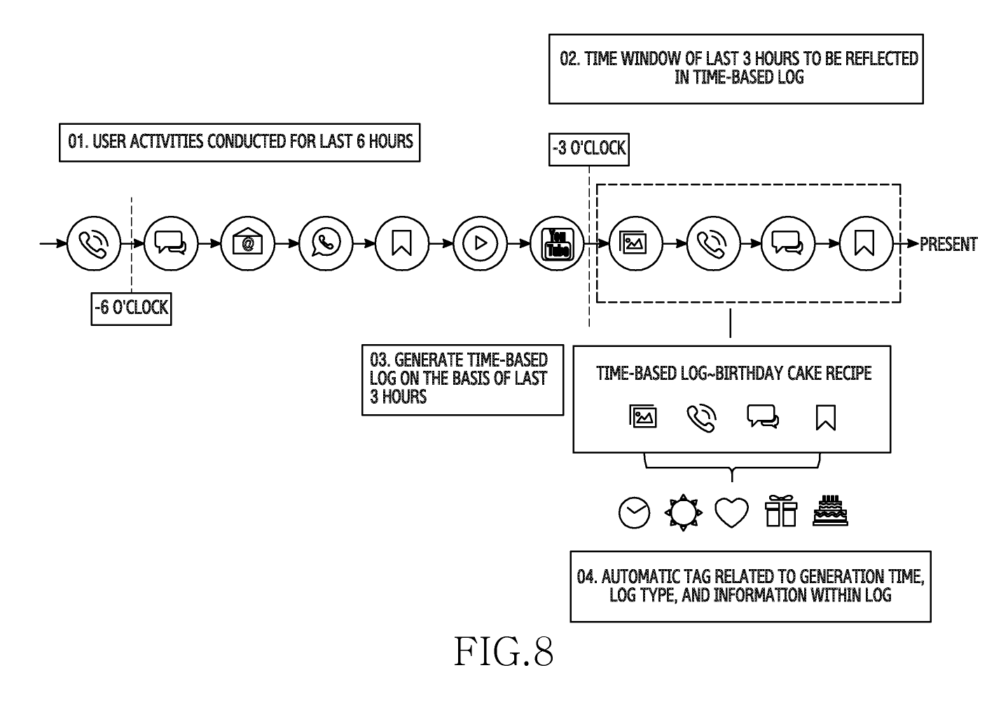

FIG. 8 illustrates an image representation of the operation of FIGS. 7A to 7C according to an embodiment of the present disclosure.

Referring to FIG. 8, the time-based log may be configured in accordance with the last 3 hours. More specifically, the time-based log may be configured from a point (−3 o'clock) that is 3 hours before the current time. In other words, a time window of the last 3 hours may be selected to acquire information and generate the log. Information related to all operational events such as messaging, photo capturing, phone calls, and video recording may be collected and corresponding elements may be located within the time-based log. Further, a time window comprising any time period may be selected.

Further, various tags may be automatically associated with elements in the time-based log. For example, the presence of a birthday cake related keyword within any of the elements will lead to an automatic incorporation of a “birthday cake,” “gift,” “party,” and the like related tags upon the specific element in the time-based log or upon the time-based log itself.

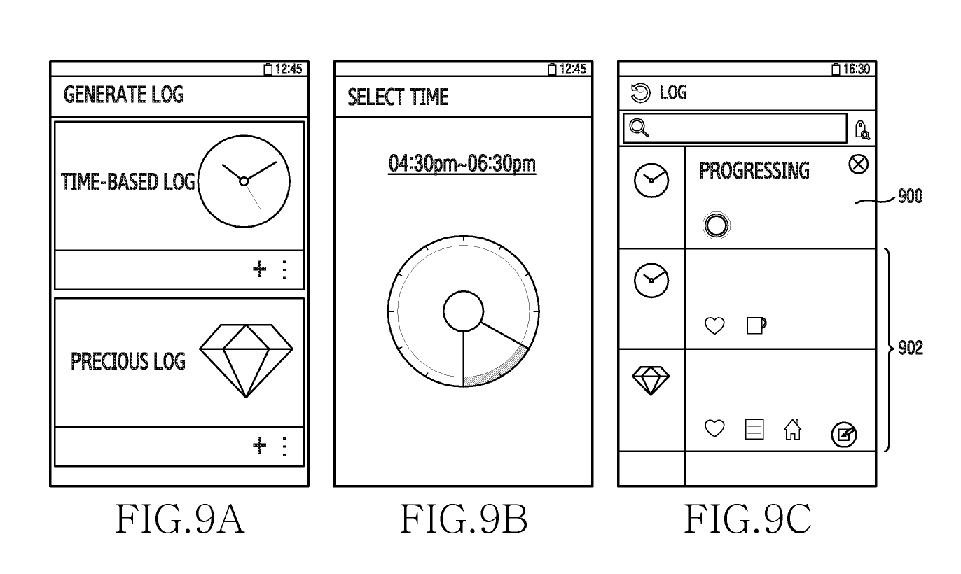

FIGS. 9A, 9B, and 9C illustrate another type of operation related to FIG. 6 through a user interface application according to an embodiment of the present disclosure. FIGS. 9A to 9C illustrate the generation of a time-based log through a user interface.

Referring to FIG. 9A, a time-based log (i.e., time-based log 900 of FIG. 9C) may be one of a plurality of options for generating the log. According to the selection of the option, the user may further select a future time interval, for example, from 4:30 p.m. to 6:00 p.m. as illustrated in FIG. 9B. As a result, the mobile device may show that a configuration of the time-based log 900 is being progressed at 4:30 p.m. in the time-based log 900 as illustrated in FIG. 9C. While progressing the configuration of the time-based log 900, the mobile device may allow access of the user to an already generated log 902 based on a user's request.

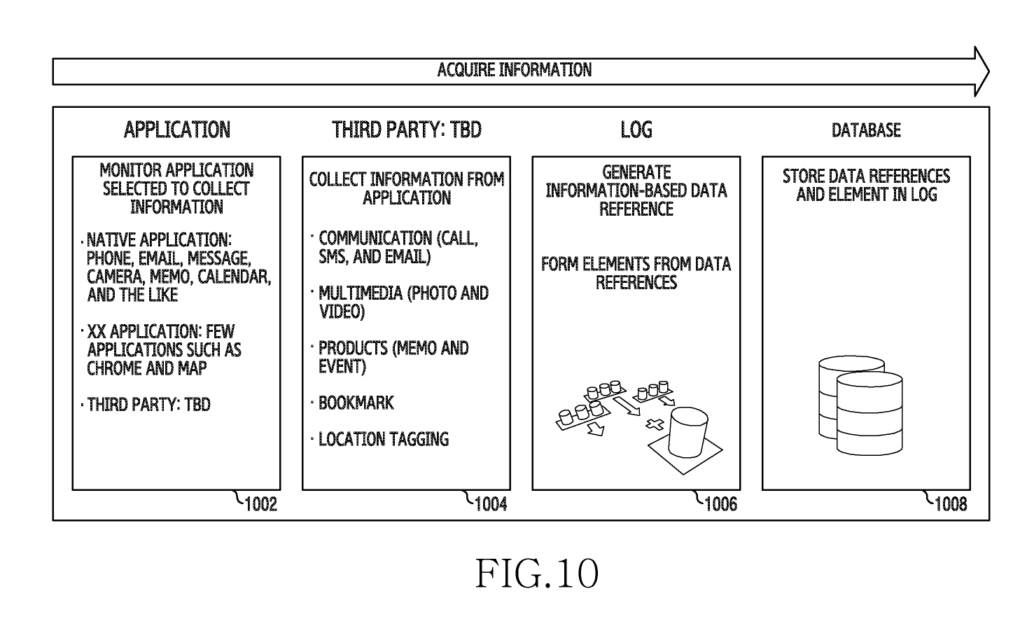

FIG. 10 illustrates the operation of FIG. 1 according to relevant entities according to an embodiment of the present disclosure.

Referring to FIG. 10, a first entity 1002 may process mobile applications. The first entity 1002 may select applications based on a user-provided condition for collecting information. For example, the applications may include native applications and third party applications. Further, the first entity 1002 may monitor applications selected for collecting information. Similarly, the first entity 1002 may consider applications executed in an external device (for example, a smart watch, a device, or the like) connected to the mobile device based on the type of user specific condition or a user's demand to collect information. The first entity 1002 may consider various applications to collect information in the mobile device.

A second entity 1004 may process a user activity in the selected application. For example, the user activity may include downloading a song, receiving/transmitting a call, exchanging a message, and wireless interaction with another device. That is, the second entity 1004 may collect information from the application. The second entity 1004 may form an input for a third entity 1006 based on a type and result of the activity.

The third entity 1006 may process the log based on the collected information. The third entity 1006 may detect data references based on the collected information, group the detected data references to form elements, and connect and tag the elements. That is, the third entity 1006 may register the information collected from the user activity through the applications as elements of the log based on a time line indicating the generation of an operational event. When expressing the log, the third entity 1006 may automatically make tags related to elements and add the tags based on a user's request. For reference, the user may add other tags to the element or record. When an external device, such as a smart watch, is connected to the mobile device, the log may be separately stored. That is, in order to save memory space within the mobile device, the log may be separately stored in the mobile device and the external device. Nevertheless, the data references or groups of the data references may be registered in the log based on identifiers of elements, and thus, there is no duplication of data in the mobile device and the external device.

A fourth entity 1008 may process a database maintained by the memory of the mobile device. For example, when the mobile device is driven by an Android operating system (OS), a SQLite database may be used to store actual contents. The fourth entity 1008 may store only relevant data, that is, groups/elements of data references existing in a connected form within the log or data references/individual elements, which are not grouped, in a predetermined database. For example, in the time-based log, while information related to only a caller/callee name and number is stored within a predetermined database, complete details of a call may be stored in a default call log database maintained by the database.

Meanwhile, the location-based log in which all elements are connected to each other based on a common location may be configured. For example, while the user is at a geographical coordinate of a railway station in New Delhi, the mobile device may generate all operational events generated within the mobile device as the location-based logs. Once the user moves to another geographical location, the mobile device may stop generating the location-based log and automatically store the location-based log.

Meanwhile, a user body state-based log may be configured. While the user maintains a particular body state, the mobile device may register all operational events generated within the mobile device as elements of the logs, for example, a jogging state log, a driving state log, and the like. To this end, the mobile device may detect a user body state and acquire information while the user body state is maintained.

Meanwhile, a keyword-based log for collecting all operational events based on the existence of a keyword may be configured. For example, the user may define “Bill” as a keyword, and the mobile device may classify contents having Bill (message, email, and contacts) as a Bill log.

Meanwhile, an application-based log based on the use or type of an operation performed through one or more predetermined applications may be configured. For example, operational events performed through an app like sharing particular contents, preferring particular contents, or calling an unknown phone number may be collected. Accordingly, the application-based log such as a sharing log, a sign log, an unknown phone number log, a self-taken photo log, or a selfie log may be configured. Therefore, such an application-based log may include various elements according to a particular type of operation. For example, the selfie log may include only self-taken photos.

Meanwhile, an interaction-based log, which is on the basis of an interaction between the mobile device and an external device, may be configured. For example, when an image stored in the mobile device is displayed on the external device, the interaction-based log may be a set of elements that denote the occurrence of streaming or interaction with the external device. Accordingly, the interaction-based log may not only notify the user of the interaction with the external device but also lead the user to access contents streamed from the main memory.

Meanwhile, a user-based log configured by the user may be constructed. The user may manually configure any action or activity performed in the mobile device to be constructed as the user-based log. For example, after having an important chat with an unknown caller, the user may simply select details of the chat to be constructed as the user-based log. In other words, the user-based log corresponds to a user customized log, and may be formed by direct selection of one or more operational events by the user within the mobile device.

Further, the elements within the log, or the log itself, may be automatically marked with tags or identifiers. For example, the elements within the log, or the log itself, may be automatically tagged with day/night tags based on the date and time thereof. Accordingly, the mobile device may associate the tags or identifier with the elements within the log or the log.

For example, when the log includes a message having text of a birthday, tags or identifier such as a gift box and birthday cake stickers may be automatically associated with the log or the recap. Similarly, while a location-based log is configured, the mobile device at a particular location may download a menu of a restaurant existing within that location. Accordingly, a “fork and knife”-based tag may be affixed to the location-based log or a corresponding element within the location-based log. As the user identifies a log being constructed or a pre-generated log, the tags may be manually associated with the log or the elements within the log by the user.

An operation of the above embodiments will be described to illustrate the retrieval of a particular log from a plurality of pre-generated logs and a structure of particular information. A user instruction to perform such a search operation may include a search query that includes one or more of a keyword, a tag, a special character, and any other parameter, such as a pattern according to a voice command or a touch gesture.

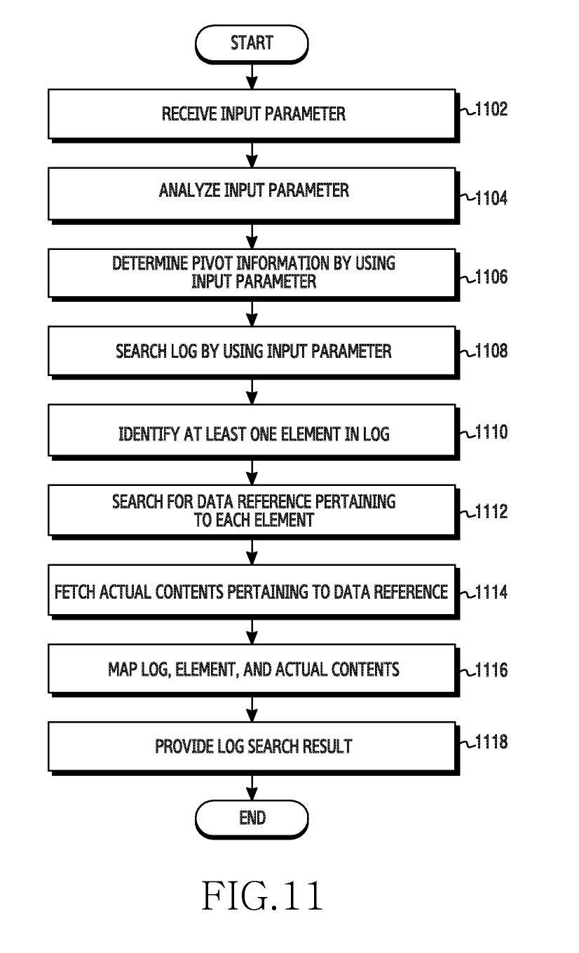

FIG. 11 illustrates operations according to embodiments of the present disclosure. FIG. 11 illustrates an operation for the methods according to the embodiments of FIGS. 3 and 5. FIG. 11 may show the methods illustrated in FIGS. 3 and 5 through successive operations but the present disclosure is not limited thereto.

Referring to FIG. 11, the input device 402 of the mobile device 400 receives an input parameter through a user input in operation 1102. The input parameter may be received through a user interface and may correspond to a predefined identifier in the form of user text, such as a keyword, tag, number, character, combined character of English and number, and special character. The input parameter may include a user type parameter or a selected parameter. The tag may be provided by the user through the selection of an image, a sign, a special character, or the like. In another example, the input parameter may be a pattern drawn through a voice-based command or a touch gesture. In yet another example, the input parameter may be a photo or an image acquired by a camera or another type of image device based on a search for a particular log and a representation of particular information. The user input received in operation 1102 may be a search query for searching for one or more relevant logs and finding relevant information. Operation 1102 may correspond to operation 302 of FIG. 3 and operation 502 of FIG. 5.

The processor 404 of the mobile device 400 may analyze the input parameter in operation 1104. For example, a recap user input analyzer of the processor 404 may analyze the input parameter. When the photo/image/video acquired by the camera acts as the input parameter, the recap user input analyzer may parse the photo/image/video acquired by the camera to analyze the photo/image/video. Accordingly, the recap user input analyzer may automatically generate sequentially analyzed intermediate keyword(s). Operation 1104 may correspond to operation 302 of FIG. 3 and operation 502 of FIG. 5.

The processor 404 of the mobile device 400 may use the input parameter analyzed in the previous operation for determining pivot information in operation 1106. The pivot information may be a category of logs such as the time-based log, the location-based log, and the user-based log, or the other log category described above. Accordingly, the pivot information may be a combination of a keyword and a tag, and may indicate total context related to the input parameter. The pivot information may be acquired from the database of the mobile device 400. For example, a recap pivot matcher module of the processor 404 may acquire the pivot information from the log database. Operation 1106 may correspond to operation 302 of FIG. 3 and operation 502 of FIG. 5.

The processor 404 of the mobile device 400 may use the input parameter for searching for a particular log identification (ID) in the log database in operation 1108. The log search may be performed within the logs related to the pivot information determined in operation 1106. For example, the log ID may include the same tag as the tag provided within the user input of operation 1102. Operation 1108 may be executed by a recap tag matcher module of the processor 404. Operation 1108 may correspond to operation 302 of FIG. 3 and operation 502 of FIG. 5.

In operation 1110, the processor 404 of the mobile device 400 may identify at least one element within the log corresponding to the log ID found in operation 1108. One of the identified elements may correspond to the analyzed input parameter, and the remaining elements of the elements identified within the log may be independent from the analyzed input parameter or may be identified from the log ID based on the proximity of the linkage of the identified element directly corresponding to the input parameter. For example, there are three or four identified elements as display information within the log. Operation 1110 may be executed by a raw reference data group matcher module, which operates based on a reference-data group database in the processor 404. As described above repeatedly, the identified elements may be a group of similar data references or all individual data references that are not grouped. Operation 1110 may correspond to operation 304 of FIG. 3 and operation 504 of FIG. 5.

In operation 1112, the processor 404 of the mobile device 400 may search for at least one data reference pertaining to each of the elements identified in operation 1110. Further, data references pertaining to the element, which is not identified, existing within at least one log may be searched for in a raw data reference database. Operation 1112 may be executed by a data reference matcher module, which operates based on the raw data reference database. Operation 1112 may correspond to operation 306 of FIG. 3 and operation 506 of FIG. 5.

The processor 404 of the mobile device 400 may fetch actual contents pertaining to the at least one data reference from the main memory of the database in operation 1114. The contents may include first type contents pertaining to one of the identified elements that directly pertains to the input parameter. Second type contents may pertain to other types of identified elements that do not pertain to the input parameter. Further, contents pertaining to elements that are not identified within the log may be also found. Operation 1114 may be executed by a data fetcher module, which operates based on the main memory of the mobile device 400. Operation 1114 may correspond to operation 306 of FIG. 3 and operation 506 of FIG. 5.

The processor 404 of the mobile device 400 may fetch mapping from between the log ID, the identified element, and the actual contents in operation 1116. The processor 404 of the mobile device 400 may provide a search result of the log in operation 1118. That is, the processor 404 may provide a graphic user interface of the log based on cached or pre-defined details pertaining to the log ID retrieved in the previous operations. The processor 404 may at least partially display the fetched contents by representing the first type contents and the second type contents in the graphic user interface of the log. Locations of the first type contents and the second type contents with respect to each other may be maintained in accordance with each other in line with the orientation/linkage/sequence as depicted in the log. More specifically, when the mapping described in operation 1116 is performed, the processor 404 may render the display device 406 to provide the graphic user interface of the log.

Operations 1116 and 1118 may correspond to operation 308 of FIG. 3 and operation 508 of FIG. 5. Further, the input device 402 may receive a user input for accessing contents other than the contents displayed as display information. Based on the user input, contents fetched in connection with the non-identified element may be expressed by a direction of the non-identified element within the log. In other words, the user may identify total information existing in the log ID instead of the display information.

Expression of the first type contents and the second type contents within the graphic user interface may include a symbol expression (for example, image or thumbnail expression) related to each identified element and metadata included in the identified elements. The symbol expression is realistically practicable, and may be executed by the user to access detailed data included in the identified elements within the mobile device 400. For example, message symbol expression may be clicked to access an actual message and details (for example, contact details of a caller/callee). In another example, a graphic user interface of at least one log may be expressed and, accordingly, display information may be expressed according to each log ID.

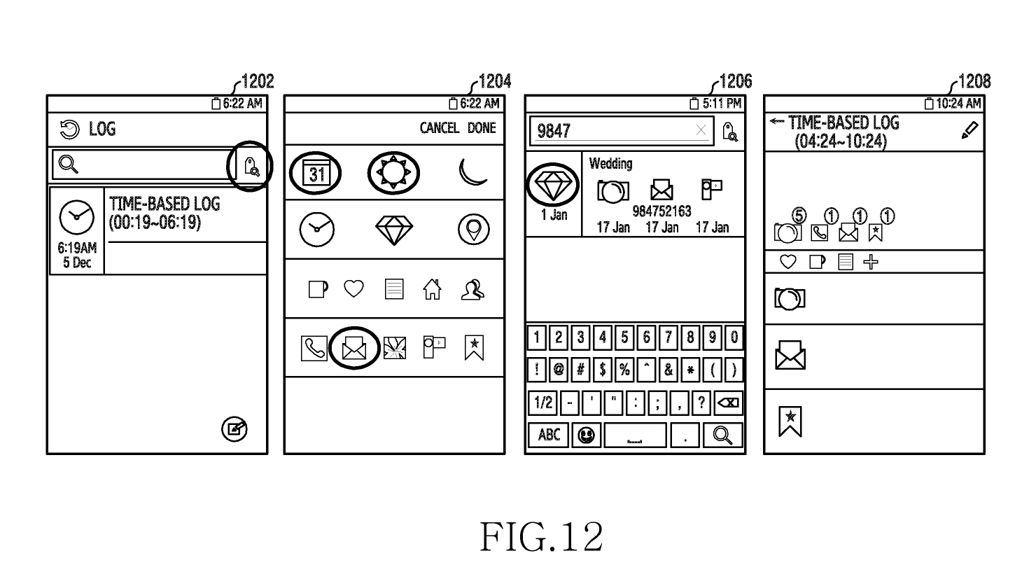

FIG. 12 illustrates an operation associated with FIG. 11 through a user interface according to an embodiment of the present disclosure.

Referring to FIG. 12, the mobile device 400 may display a user interface indicating a set of pre-generated logs in operation 1202. A search field (that is, a text box field) may be provided to receive a search query for searching for one or more particular logs.

In a scenario, the user may search for photos taken on January 17 while exchanging messages based on a phone number starting with “9847”. The user may desire to reproduce such a scenario in the form of a search query. When the user clicks a control icon (circle part of operation 1202), the mobile device 400 may display a user interface including tags for reproducing a search scenario in operation 1204. When the user selects calendar, daytime, and tags, such as message-based tags, to reproduce the desired search scenario, the mobile device 400 may display a user interface including a search field in operation 1206. When the user inputs “984T” into the search field, the mobile device 400 may acquire a log in operation 1206 as illustrated in FIG. 12. At this time, the mobile device 400 may display not only contents directly linked to the tags and text but also contents that are not linked to text. This is because the contents, which are not linked to the text, correspond to a part of the relevant log (which matches the tags) and are close to the contents directly related to the text. Accordingly, the graphic user interface of the log and the contents may be displayed. Further, the displayed contents may be identified by metadata (that is, January 17) included in the displayed contents. In other words, in operation 1206, the log may indicate not only a message exchanged according to the text “9847” but also a “relevant” activity, such as photos and videos, conducted while the corresponding message is exchanged. Accordingly, the user may use a “relevant search function” to acquire photos without clearly specifying a photo activity as the search query. When the user clicks a log icon (circle part of operation 1206), the mobile device 400 may activate the log, which has been acquired in operation 1206, in operation 1208. Accordingly, the user may identify an order of an operational event through details of the log. Further, when the user clicks an element (for example, photo) of the log, the corresponding element may be separated and an individual operation, for example, photo view or deletion may be performed.

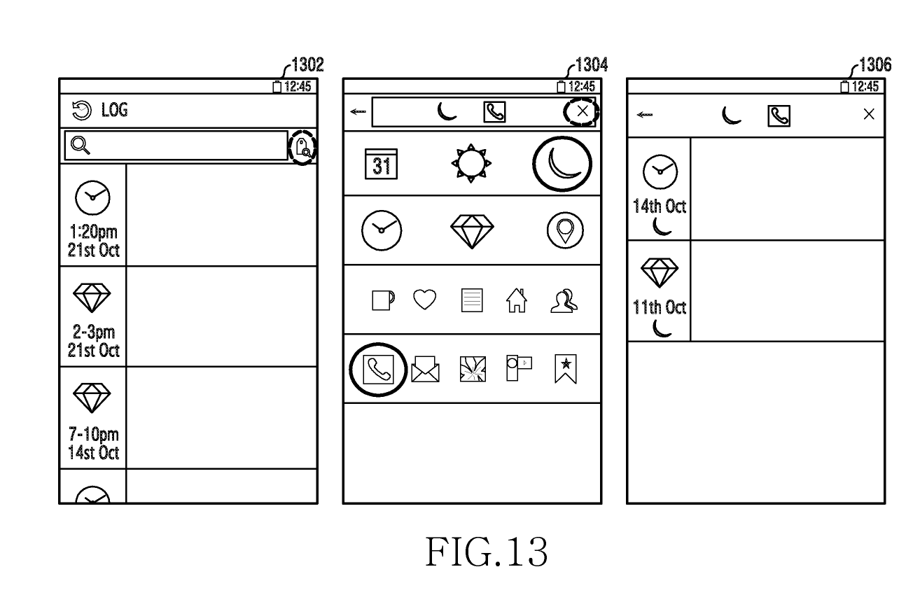

FIG. 13 illustrates another type of operation associated with FIG. 11 through a user interface according to an embodiment of the present disclosure.

Referring to FIG. 13, the mobile device 400 may display a plurality of logs and a considerable amount of display information according to the logs. In this case, the mobile device 400 may perform a search across the pre-generated logs in operation 1302. Meanwhile, the mobile device 400 may display tags to be applied as a part of the search query in the search field in operation 1304. Accordingly, the mobile device 400 may display two or more relevant logs or log IDs in operation 1306, and all of the logs and the log IDs may include tags except for tags input by the user as the search query.

Similarly, examples provided in FIGS. 12 and 13 may be implemented to receive an image captured by a mobile device camera as a part of the search query. The image may be inserted into the search field by the user through various means known in the art. In another example, while the mobile device operates based on the search field, the user may simultaneously capture the image and insert the image captured as the search query into the search field.

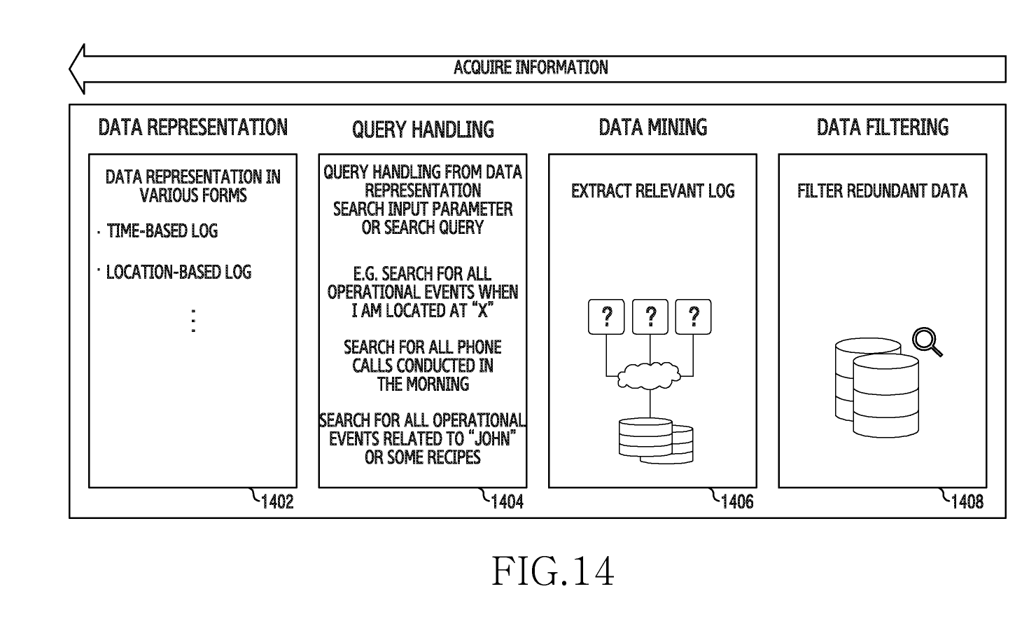

FIG. 14 illustrates the operations of the second embodiment and the third embodiment according to relevant entities according to an embodiment of the present disclosure.

Referring to FIG. 14, a first entity 1402 may perform “data representation” in various forms in accordance with a user interface in operation 1202 of FIG. 12 and operation 1302 of FIG. 13. For example, the data representation may depict a set of pre-stored logs, such as the time-based log and the location-based log.

A second entity 1404 may perform “query handling” from the “data representation” in accordance with a user interface in operation 1204 of FIG. 12 and operation 1304 of FIG. 13. For example, the second entity 1404 may receive a search input parameter or a search query from the user through the search field. The second entity 1404 may correspond to operation 1102 of FIG. 11.

A third entity 1406 may perform “data mining.” For example, the third entity 1406 may analyze the search input parameter or the search query, extract at least one relevant log ID, and display, as display information, relevant contents as a part of the log. The third entity 1406 may correspond to operation 1104 to operation 1114 of FIG. 11.

A fourth entity 1408 may perform “data filtering.” The fourth entity 1408 may perform the “data filtering” based on a log database to filter redundant data so as to ignore the redundant data while the third entity 1406 performs the “data mining.” In another scenario, the fourth entity 1408 may periodically perform the “data filtering” based on the log data in order to filter the redundant data from the logs.

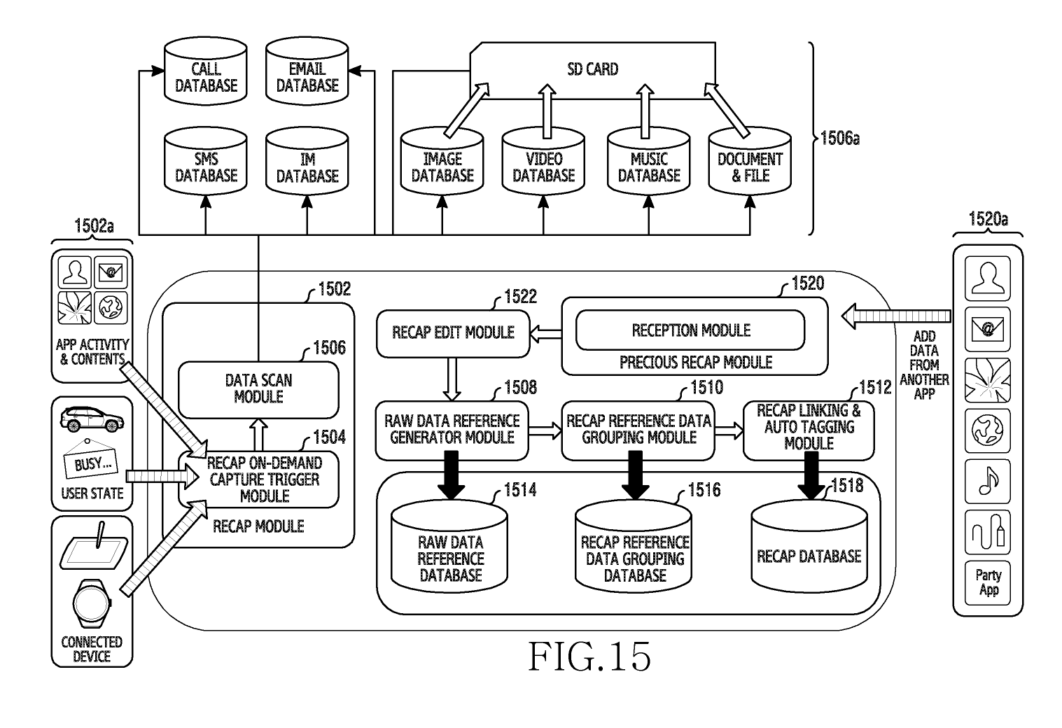

FIG. 15 illustrates a detailed structure of the mobile device 200 illustrated in FIG. 2 according to an embodiment of the present disclosure.

Referring to FIG. 15, the mobile device 200 may include a recap module 1502 for generating a log based on a user specific condition 1502a. The recap module 1502 may include a combination of sub modules, such as a recap on-demand capture trigger module 1504, to perform operation 102 of FIG. 1 and a data scan module 1506 to perform operation 104 of FIG. 1. At this time, the data scan module 1506 may be triggered by the recap on-demand capture trigger module 1504.

More specifically, the data scan module 1506 may scan for contents generated or received according to the generation of an operational event within the mobile device 200. For example, the contents may include events/data, such as a phone call, an email, a message, played music, a captured photo, a captured video, and the like. Accordingly, the data scan module 1506 may interact with the main memory of the mobile device 200 to scan for contents, such as contacts, a message, a video, an image, and the like. Further, the data scan module 1506 may scan for contents in a secure digital (SD) card or another storage medium 1506a for contents. In addition, the mobile device 200 may include a raw data reference generator module 1508, a recap reference data grouping module 1510, and a recap linking and auto tagging module 1512 to perform operation 106 and operation 108 of FIG. 1. A separate function of each module has been described in operation 610, operation 612, and operation 614 of FIG. 6.

Further, the mobile device 200 may include a raw data reference database 1514 to store data references related to the acquired data, a recap reference data grouping database 1516 to store a group of similar data references, and a recap database 1518 to store the generated logs.

In addition, the mobile device 200 may further include a precious recap module 1520 that helps the user manually select contents to be configured in the log. Accordingly, the precious recap module 1520 may include a reception module for receiving a user selection of various types of operational events 1520a to be included in the log. Such a log may be the precious log.

The data scan module 1506 may not be used for configuring the precious log, but the raw data reference generator module 1508, the recap reference data grouping module 1510, and the recap linking and auto tagging module 1512 may be used for configuring the precious log.

Further, a recap edit module 1522 may be provided to enable the user to edit all logs and store them in an updated form. While selecting contents to configure the precious log, the user may edit the selected contents through the recap edit module 1522 before finally acquiring the precious log.

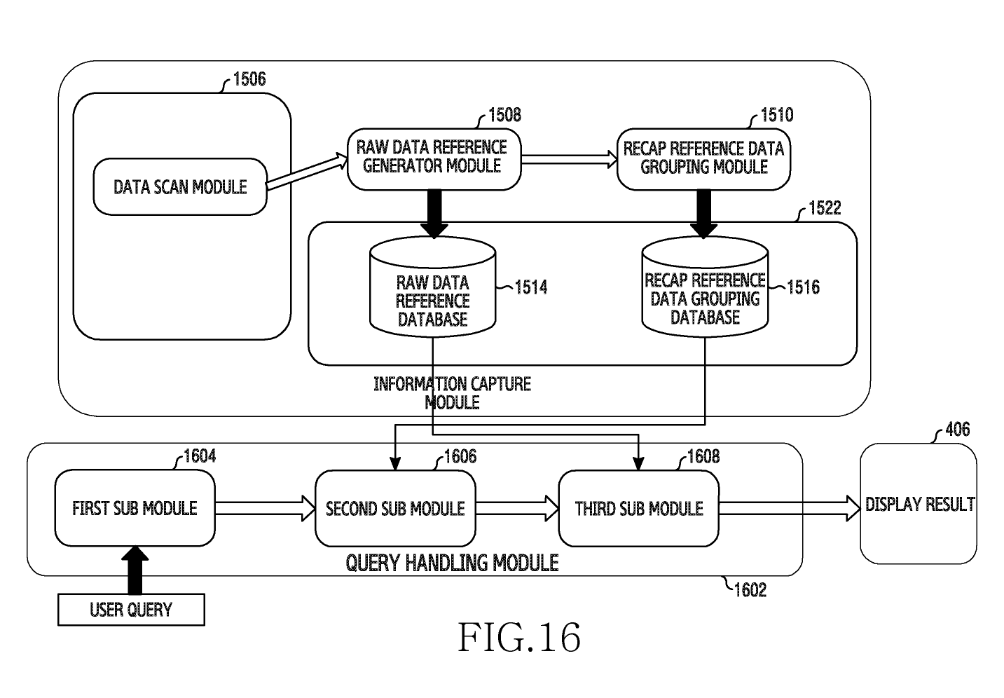

FIG. 16 illustrates a detailed structure of the mobile device 400 illustrated in FIG. 4 according to an embodiment of the present disclosure.

Referring to FIG. 16, the mobile device 400 may include a query handling module 1602. The query handling module 1602 may include sub modules a query handler (analyzer/parser) corresponding to a first sub module 1604, a reference search module corresponding to a second sub module 1606, and a reference combination module corresponding to a third sub module 1608. When the first sub module performs the function illustrated in operation 1104 of FIG. 11, the second sub module 1606 may be a combination of a recap pivot matcher module, a recap tag matcher module, a reference data group matcher module, a data reference matcher module, and a data fetching module as illustrated in operation 1106 to operation 1114 of FIG. 11. Accordingly, the second sub module 1606 may perform the functions illustrated in operation 1106 to operation 1114 of FIG. 11. The third sub module 1608 may correspond to the data reference matcher module and may perform the function illustrated in operation 116 of FIG. 11.

The display device 406 may perform a display function as illustrated in operation 108 of FIG. 1 or operation 1118 of FIG. 11.

Further, the second sub module 1606 may generate various types of references, for example, pivot information, log ID, element, and data reference and thus interact with the recap database 1518 and the recap reference data grouping database 1516. The third sub module 1608 may combine references by drawing mapping through relational databases, fetch contents in accordance with the drawn mapping, and display the log and particular contents within the log through the display device 406. Accordingly, the third sub module 1608 may interact with the second sub module 1606 and the raw data reference database 1514.

Pivot information and the log ID may be extracted from the recap database 1518, and element related information and data reference related information may be extracted from the recap reference data grouping database 1516 and the raw data reference database 1514, respectively. Finally, actual contents may be fetched from the main memory of the mobile device 400.

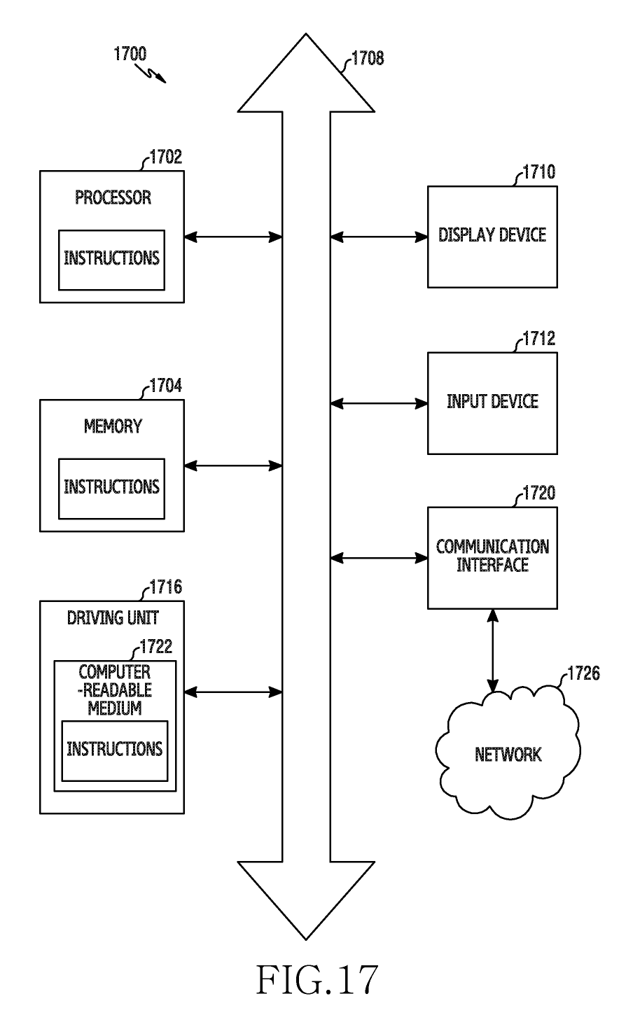

FIG. 17 illustrates an implementation of the mobile device illustrated in FIGS. 2 and 4 in a computing environment according to an embodiment of the present disclosure. FIG. 17 illustrates a hardware configuration of the mobile device 200 or 400 in the form of a computer system 1700. The computer system 1700 may include a set of instructions which can be executed to perform one or more of the aforementioned methods. The computer system 1700 may operate as a standalone device and may be connected to other computer systems or peripheral devices through a network.

Referring to FIG. 17, the computer system 1700 may operate as a client user computer in a server-client user network environment or as a peer computer system in a peer-to-peer (or distributed) network environment based on the capacity of a server. The computer system 1700 may be implemented as a PC, a tablet PC, a PDA, a mobile device, a palmtop computer, a laptop computer, a desktop computer, a communications device, a wireless telephone, a land-line telephone, a web appliance, a network router, switch or bridge, or another device. Further, although the single computer system 1700 is illustrated, the term “system” may be exchangeable with a combination of systems or sub systems that operate individually or cooperatively.

The computer system 1700 may include a processor 1702, which may be, for example, at least one of a CPU and a graphics processing unit (GPU). The processor 1702 may be a component in various systems. For example, the processor 1702 may be a part of a standard personal computer or a workstation. The processor 1702 may be one or more general processors, digital signal processors, application specific integrated circuits, field programmable gate arrays, servers, networks, digital circuits, analog circuits, combinations thereof, or other devices for analyzing and processing data. The processor 1702 may execute a software program, such as code generated (for example, programmed) manually.

The computer system 1700 may include a memory 1704 capable of communicating through a bus 1708. The memory 1704 may be a main memory, a static memory, or a dynamic memory. The memory 1704 may be a computer-readable storage medium including at least one of various types of volatile or non-volatile storage media. The memory 1704 may include at least one of a random access memory (RAM), read-only memory (ROM), programmable ROM (PROM), electrically programmable ROM (EPROM), electrically erasable and programmable ROM (EEPROM), flash memory, magnetic tape or disk, and optical media. For example, the memory 1704 includes a cache or a RAM for the processor 1702. In another example, the memory 1704 may be separated from the processor 1702 like a cache memory of the processor 1702, a system memory, or another memory. Meanwhile, the memory 1704 may include an external storage device or a database for storing data. For example, the memory 1704 may include at least one of a hard drive, compact disc (CD), DVD, memory card, memory stick, floppy disc, universal serial bus (USB) memory device, and any other device which may operate to store data.

The memory 1704 may operate to store instructions, which may be executed by the processor 1702. The aforementioned functions or operations may be performed as the processor 1702 executes the instructions stored in the memory 1704. The aforementioned functions or operations are not limited to a particular type of instruction set, storage media, processor, or processing strategy, and may be performed by at least one of software, hardware, integrated circuits, firm-ware, micro-code, and the like. Similarly, the processing strategy may include multiprocessing, multitasking, parallel processing, and the like.

The computer system 1700 may further include a display device 1710. For example, the display device 1710 may include at least one of a liquid crystal display (LCD), an organic light emitting diode (OLED), a flat panel display, a solid state display, a cathode ray tube (CRT), a projector, a printer, or another display device for outputting information. The display device 1710 may provide an interface for displaying the operation of the processor 1702 to the user, that is, an interface with software stored in the memory 1704 or a driving unit 1716.

Further, the computer system 1700 may further include an input device 1712 configured for an interaction between the user and components of the computer system 1700. For example, the input device 1712 may include at least one of a number pad, a keyboard, or a cursor control device, such as a mouse, or a joystick, touch screen display, remote control device, and any other input device that may interact with the computer system 1700.

The computer system 1700 may further include a disk or optical driving unit 1716. The driving unit 1716 may include a computer-readable medium 1722, which may store one or more sets of instructions such as software. The instructions may include at least one of the aforementioned methods or logics. In a particular example, the instructions may reside completely, or at least partially, within at least one of the memory 1704 and the processor 1702 during execution by the computer system 1700. The memory 1704 and the processor 1702 may include the computer-readable medium 1722.

As described above, the computer-readable medium 1722 may include instructions, or receive and execute instructions 1724 so that the computer system 1700 may communicate voice, video, audio, image, or other data through a network 1726. The instructions may be transmitted and received over the network 1726 through a communication interface 1720 or transmitted and received using the bus 1708. A communication port or the communication interface 1720 may be a part of the processor 1702 and may be separated from the processor 1702. The communication port or the communication interface 1720 may be configured to connect to the network 1726, an external medium, the display device 1710, or any other components in the computer system 1700, or a combination thereof. The connection to the network 1726 may be a physical connection, such as a wired Ethernet connection or may be established wirelessly. Similarly, an additional connection of another component of the computer system 1700 may be a physical connection or may be established wirelessly. The network 1726 may be directly connected to the bus 1708.

The network 1726 may include a wired network, a wireless network, an Ethernet audio video bridging (AVB) network, or a combination thereof. The wireless network may be a cellular telephone network, an 802.11, 802.16, 802.20, 802.1Q or a worldwide interoperability for microwave access (WiMax) network. Further, the network 1726 may be a public network such as the Internet, a private network such as an intranet, or a combination thereof, and may utilize a variety of networking protocols as well as transmission control protocol/internet protocol (TCP/IP) based networking protocols.

In another example, dedicated hardware implementations such as application specific integrated circuits, programmable logic arrays, and other hardware devices can be constructed to implement various parts of the computer system 1700.

Applications may broadly include a variety of electronic and computer systems. The aforementioned functions may be performed using two or more specific interconnected hardware modules or devices related to control and data signals that can be communicated between and through the modules, or as portions of an application-specific integrated circuit. Accordingly, the computer system 1700 may include software, firmware, and hardware implementations.

The computer system 1700 may implement software programs executable by the computer system 1700. In a non-limited example, implementations may include distributed processing, component/object distributed processing, and parallel processing. Meanwhile, virtual computer system processing may be constructed to implement various parts of the computer system 1700.

The computer system 1700 is not limited to operations based on any particular standards and protocols. For example, standards for Internet and other packet switched network transmission (for example, TCP/IP, user datagram protocol (UDP)/IP, hypertext markup language (HTML), or hypertext transfer protocol (HTTP)) may be used. Such standards may be periodically superseded by faster or more efficient equivalents having essentially the same functions. Accordingly, replacement standards and protocols having the same or similar functions as those disclosed are considered equivalents thereof.

In view of the aforesaid description, characteristics of the present disclosure may be to separate contents in the mobile device based on pre-set conditions like a user state, mobile apps, user-activities in the mobile device, interactions with a connected external device, and the like. The mobile device 200 or 400 may consume low memory by using reference links instead of copy data or processing contents only upon receiving a user provided demand. No background index service is required for retrieving the information, as the index is created on a demand basis. In addition, the mobile device 200 or 400 may consume low power by initiating the recap construction only when demanded by the user. Even in terms of constructing the recap, the mobile device 200 or 400 may schedule power-draining processing activities only when the mobile device is connected to an external power source or in idle/less-occupied state.

In connection with the search for information within the mobile device, the characteristics of the present disclosure may be to search for and retrieve information based on the principle of “associative memory.” Such search results may acquire results that cannot be generally found such as tags or keywords. As the search mechanism resembles a human being's mental model, which searches for and discovers a physical object, the user may easily recall such an information search method. This is in contrast to the search string-based search of the related art that searches for contents by looking for something, which exactly matches search strings of the related art, and giving a weighted value to the search results statistically. Meanwhile, the search mechanism may form a relationship between the search results and may fetch a result for which a search key cannot be formed easily or has been forgotten by the user.

The log contemplated by the characteristics of the present disclosure may record the natural sequence of event occurrences with relevant, inherent metadata and may grow it further by forming and weaving the relationship of information in a meaningful way.

With the proposed database design based on the characteristics of the present disclosure, associations between different fragmented activities may be created without actually duplicating the contents, thereby using minimal space in the mobile device 200 or 400. Thus, even though the user might not recall what he/she actually wants to search for, the user may easily recall it through these associations.

Overall, the aforementioned information search method may use not only keywords/tags of contents, but also various relationships between elements within the log.

While specific language has been used to describe the disclosure, the present disclosure is not limited thereto. As would be apparent to those skilled in the art, various working modifications may be made to the method in order to implement the inventive concept.

The drawings and the forgoing description provide embodiments of the present disclosure. Those skilled in the art will appreciate that one or more of the described elements may well be combined into a single functional element. Alternatively, a certain element may be split into a plurality of functional elements. Elements from one embodiment may be added to another embodiment of the present disclosure. For example, orders of processes described herein may be changed and are not limited to the manner described herein. Moreover, the operations of any flow diagram do not need to be implemented in the order shown. Also, not all the operations need to be necessarily performed. Operations that are not dependent on other operations may be performed in parallel with the other operations. The scope of embodiments is by no means limited by these specific embodiments of the present disclosure. Numerous variations, whether explicitly given in the specification or not, such as differences in structure, dimension, and use of material, are possible. The scope of embodiments is at least as broad as given by the following claims.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of searching for information in a mobile device, the method comprising:
identifying at least one log for operational events based on at least one input parameter;
identifying at least one element existing within the at least one log based on the at least one input parameter;
fetching contents related to the at least one element from the at least one log; and
displaying a portion of the contents.

2. The method of claim 1, wherein the identifying of the at least one element comprises identifying at least two elements existing within the at least one log based on the at least one input parameter.

3. The method of claim 2,
wherein the identifying of the at least one log comprises determining the at least one log among a plurality of pre-generated logs, and
wherein the at least one log is determined based on at least one of context associated with the at least one input parameter and at least one predetermined identifier, which exists within the at least one input parameter and corresponds to at least one of a tag, image, sign, and special character.

4. The method of claim 1,
wherein a plurality of elements indicate occurrences of the operational events, and
wherein the plurality of elements are linked in a predefined order within the log based on at least one of a chronological sequence of the operational events, a location of occurrence of the operational events, presence of one or more identical keywords between the elements, a sequence of interactions of the mobile device with an external device, one or more pre-defined user activities through the mobile device while the mobile device operates, and a sequence of user activities through one or more mobile device applications while the one or more applications are executed.

5. The method of claim 1,
wherein the at least one element indicates a type of user activity performed through the mobile device, and
wherein the user activity comprises one of a group of identical user activities and an individual activity.

6. The method of claim 1,
wherein the at least one input parameter is received through a user interface, and
wherein the at least one input parameter includes at least one of a user type parameter including at least one of a user text, a predefined identifier, a predetermined tag, a numeric character, an alphanumeric character, and a special character, an image acquired by an imaging device, a voice-based command, and a touch gesture.

7. The method of claim 2, wherein the identifying of the at least two elements comprises:
searching for at least one element within the at least one log based on the at least one input parameter, and
searching for at least one other element within the at least one log based on the found at least one element.

8. The method of claim 1, further comprising:
searching for data references pertaining to the at least one element; and
selectively searching for data references pertaining to another element that exists within the at least one log.

9. The method of claim 8,
wherein the fetching of the contents comprises extracting the contents from a predetermined memory location in the mobile device through the data references, and
wherein the contents include at least one of first type contents pertaining to the at least one input parameter and the at least one element and second type contents, which do not pertain to the at least one input parameter but pertains to the at least one element.

10. The method of claim 9, wherein the displaying of the portion of the contents comprises:
displaying a graphic user interface of the at least one log; and
displaying the first type contents and the second type contents within the graphic user interface,
wherein the first type contents and the second type contents orient with respect to each other based on the location of the at least one element in the at least one log.

11. A mobile device comprising:
a display device;
an input device configured to receive at least one input parameter; and
a processor functionally connected to the display device and the input device,
wherein the processor is configured to:
identify at least one log for operational events based on the at least one input parameter,
identify at least one element existing within the at least one log based on the at least one input parameter,
fetch contents related to the at least one element from the at least one log, and
display a portion of the contents.

12. The mobile device of claim 11, wherein the processor is further configured to identify at least two elements existing within the at least one log based on the at least one input parameter.

13. The mobile device of claim 11, wherein the processor is further configured to display the portion of the contents according to a pattern based on a location of the at least one element within the at least one log.

14. The mobile device of claim 11,
wherein, if the mobile device is in a state of one of being heavily occupied and under-charged, the processor is further configured to postpone a monitoring of information corresponding to the operational events, and
wherein, if the mobile device is in a state of one of a charging standby state, an idle state, and a low occupied state, the processor is further configured to automatically trigger the monitoring of the information corresponding to the operational events.

15. A method of acquiring information in a mobile device, the method comprising:
detecting a user specific condition;
monitoring at least one operational event based on the user specific condition;
accessing at least one element related to the at least one operational event;
generating a log of the at least one operational event; and
registering the at least one element in a predetermined location within the log.

16. The method of claim 15, wherein the detecting of the user specific condition comprises one of automatically detecting the user specific condition and receiving a user input corresponding to the user specific condition.

17. The method of claim 15,
wherein the user specific condition is selected directly by a user and defined based on one or more contents related to at least one operational event, and
wherein the accessing of the at least one element comprises generating at least one data reference related to the one or more contents.

18. The method of claim 15,
wherein the monitoring of the at least one operational event comprises scanning for data generated as a result of the at least one operational event and stored in a memory, and
wherein the accessing of the at least one element comprises generating at least one data reference related to the data.

19. The method of claim 15, wherein the at least one operational event includes at least one of an incoming call, an outgoing call, an incoming message, an outgoing message, browsing of Internet, and an operation performed by a user in the mobile device.

20. The method of claim 15,
wherein the registering of the at least one element comprises linking the at least one element to another element based on the user specific condition, and
wherein the linking is based on at least one of a chronological sequence when the user specific condition is based on a time frame or a state of a user, a sequence of content selection when the user specific condition pertains to the direct selection of content by the user in relation to one or more operational events, a geographical location when the user specific condition is based on a location, presence of a keyword when the user specific condition pertains to the keyword, a sequence of usage of one or more pre-defined applications when the user specific condition pertains to usage of the applications, and a sequence of interaction when the user specific condition pertains to the interaction of the mobile device with an external device.

21. The method of claim 20, wherein the location is determined based on the linkage with the other element.

22. The method of claim 15, further comprising tagging one of the log and element based on one of at least one tag and user input.

23. The method of claim 15,
wherein the monitoring of the at least one operational event is triggered based on a particular state of the mobile device, and
wherein the particular state includes at least one of a charging standby state, an idle state, and a low occupied state of the mobile device.

24. A mobile device comprising:
a memory;
an input device configured to receive a user specific condition; and
a processor functionally connected to the memory and the input device,
wherein the processor is configured to:
monitor at least one operational event based on the user specific condition,
access at least one element related to the at least one operational event,
generate a log of the at least one operational event, and
register the at least one element in a predetermined location within the log.

25. The mobile device of claim 24,
wherein the processor is further configured to scan for data stored in the memory, and
wherein the data is generated as a result of the at least one operational event.

26. The mobile device of claim 25, wherein the processor is further configured to:
generate a plurality of data references related to the data,
group similar data references among the data references, and
manage the at least one element based on a result of the grouping.

27. The mobile device of claim 24, wherein the processor is further configured to:
generate the log by linking the at least one element to another element based on the user specific condition, and
tag one of the log and element based on one of at least one tag and user input.

28. The mobile device of claim 24,
wherein the input device is further configured to receive one or more contents directly selected by a user and related to at least one operational event, and
wherein the processor is further configured to generate at least one data reference related to the one or more contents.
